(19) United States
(12) Patent Application Publication
(10) Pub. No.: US 2020/0167666 A1
(43) Pub. Date: May 28, 2020

(54) PREDICTIVE MODEL BASED ON DIGITAL FOOTPRINTS OF WEB APPLICATIONS

(71) Applicant: CITRIX SYSTEMS, INC., FORT LAUDERDALE, FL (US)

(72) Inventor: JEROEN MATTIJS VAN ROTTERDAM, FORT LAUDERDALE, FL (US)

(21) Appl. No.: 16/202,400

(22) Filed: Nov. 28, 2018

(51) Int. Cl. G06N 5/02; G06N 7/00

(52) U.S. Cl. CPC G06N 5/022; G06N 7/005

(57) ABSTRACT

A web server includes a web application being accessed by a plurality of users, and a processor that logs application inputs and outputs during a respective user session for each user, and creates a state diagram for each user during the respective user session based on the logged application inputs and outputs. Each state diagram represents states and transitions between the states. The processor translates each state diagram into vector space constructed by a sum of transition sequences defined by the transitions between the states, clusters similar transition sequences in each state diagram, and reduces each cluster of similar transition sequences in each state diagram into a single transition sequence. A reduced state diagram is generated for each state diagram based on the single transition sequences. The reduced state diagrams are analyzed to generate a predictive model representing a probability of state transitions between the different states.

### TECHNICAL FIELD

The present disclosure relates to web applications, and more particularly, to a predictive model to predict behavior of users when accessing a web application.

### BACKGROUND

Predictive analytics generally refers to techniques for extracting information from data to build a model that can predict an output from a given input. Predicting an output can include predicting future trends or behavior patterns. Various types of predictive models can be used to analyze data and generate predictive outputs.

Typically, a predictive model is trained with training data that includes input data and output data that mirror the form of input data that will be entered into the predictive model and the desired predictive output, respectively. The amount of training data that may be required to train a predictive model can be large, e.g., in the order of gigabytes or terabytes. The number of different types of predictive models available is extensive, and different models behave differently depending on the type of input data.

### SUMMARY

A web server includes a memory comprising a web application stored therein, and a processor coupled to the memory to perform the following based on the web application being accessed by a plurality of users. The processor logs application inputs and outputs during a respective user session for each user, creates a state diagram for each user during the respective user session based on the logged application inputs and outputs. Each state diagram represents states and transitions between the states.

The processor translates each state diagram into vector space constructed by a sum of transition sequences defined by the transitions between the states, clusters similar transition sequences in each state diagram, and reduces each cluster of similar transition sequences in each state diagram into a single transition sequence. A reduced state diagram is generated for each state diagram based on the single transition sequences. The reduced state diagrams are analyzed to generate a predictive model representing a probability of state transitions between the different states.

The processor uses the predictive model to predict behavior of a subsequent user when accessing the web application. This has several advantages.

One advantage is when the subsequent user accesses the web application via a client computing device comprising a cache memory, and the processor pro-actively pushes, based on the predicted behavior, relevant components of the web application to the cache memory before being requested by the web application.

Another advantage is for the processor to compare actual behavior of the subsequent user to the predicted behavior to determine efficiency of the subsequent user when accessing the web application.

Yet another advantage is to compare actual behavior of the subsequent user to the predicted behavior to determine anomalies of the subsequent user when accessing the web application.

The processor clusters the similar transition sequences in each state diagram using cosine distance calculations between equal events. The processor eliminates transition sequences that are not based on user input and were generated based on system events.

The predictive model comprises a Markov model. The web application comprises a Software as a Service (SaaS) application.

The application inputs being logged include at least one of keyboard events, mouse events, onload events and document object management (DOM) events. The application outputs being logged include at least one of hypertext transfer protocol (http) responses and user interface function calls.

Another aspect is directed to a method for operating a web server comprising a web application to be accessed by a plurality of users. The method comprises logging application inputs and outputs during a respective user session for each user, and creating a state diagram for each user during the respective user session based on the logged application inputs and outputs. Each state diagram represents states and transitions between the states. Each state diagram is translated into vector space constructed by a sum of transition sequences defined by the transitions between the states. Similar transition sequences are clustered in each state diagram. Each cluster of similar transition sequences is reduced in each state diagram into a single transition sequence. A reduced state diagram is generated for each state diagram based on the single transition sequences. The reduced state diagrams are analyzed to generate a predictive model representing a probability of state transitions between the different states.

Yet another aspect is directed to a non-transitory computer readable medium for operating a web server to be accessed by a plurality of users, and with the non-transitory computer readable medium having a plurality of computer executable instructions for causing the web server to perform steps as described above.

### BRIEF DESCRIPTION OF THE DRAWINGS

FIG. 1 is a block diagram of a network environment of computing devices in which various aspects of the disclosure may be implemented.

FIG. 2 is a block diagram of a computing device useful for practicing an embodiment of the client machines or the remote machines illustrated in FIG. 1.

FIG. 3 is a block diagram of a computing system that includes a web server and client computing devices that access a web application on the web server in which various aspects of the disclosure may be implemented.

FIG. 4 is a flowchart illustrating a method for generating a predictive model used to predict behavior of a subsequent user accessing the web application illustrated in FIG. 3.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

As will be appreciated by one of skill in the art upon reading the following disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

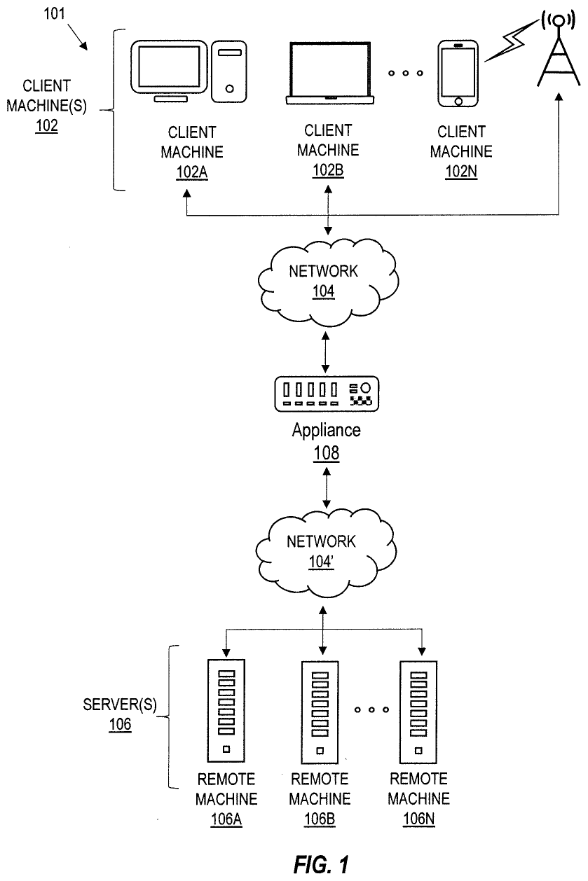

Referring initially to FIG. 1, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation client or other client or program that uses a thin-client or a remote-display protocol to capture display output generated by an application executing on a server 106 and transmits the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a WLAN, the protocols may include 802.11, Bluetooth, and Near Field Communication (NFC).

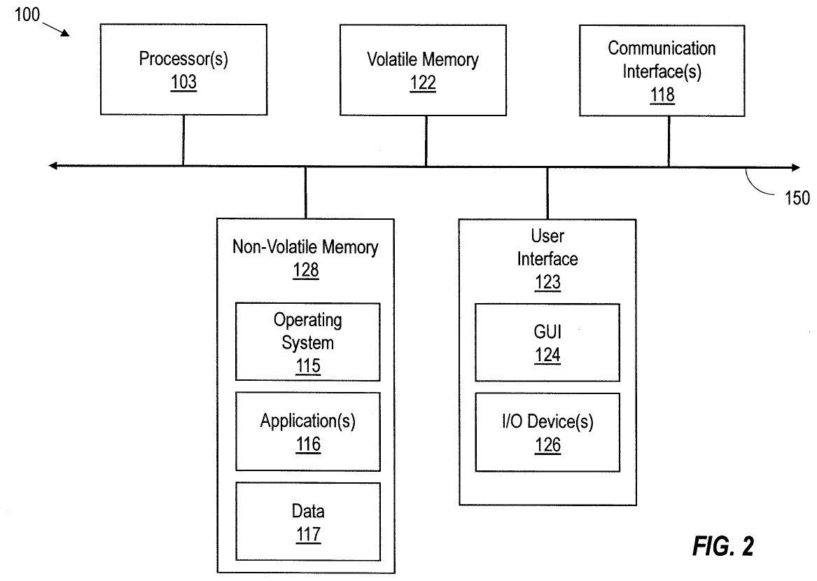

FIG. 2 depicts a block diagram of a computing device 100 useful for practicing an embodiment of client devices 102 or servers 106. The computing device 100 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid state storage media; one or more hybrid magnetic and solid state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 100 may communicate via the communications bus 150.

The illustrated computing device 100 is shown merely as an example client device or server, and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor may be analog, digital or mixed-signal. In some embodiments, the processor may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 100 may execute an application on behalf of a user of a client device. For example, the computing device 100 may execute one or more virtual machines managed by a hypervisor. Each virtual machine may provide an execution session within which applications execute on behalf of a user or a client device, such as a hosted desktop session. The computing device 100 may also execute a terminal services session to provide a hosted desktop environment. The computing device 100 may provide access to a remote computing environment including one or more applications, one or more desktop applications, and one or more desktop sessions in which one or more applications may execute.

Additional descriptions of a computing device 100 configured as a client device 102 or as a server 106, or as an appliance intermediary to a client device 102 and a server 106, and operations thereof, may be found in U.S. Pat. Nos. 9,176,744 and 9,538,345, which are incorporated herein by reference in their entirety. The '744 and '345 patents are both assigned to the current assignee of the present disclosure.

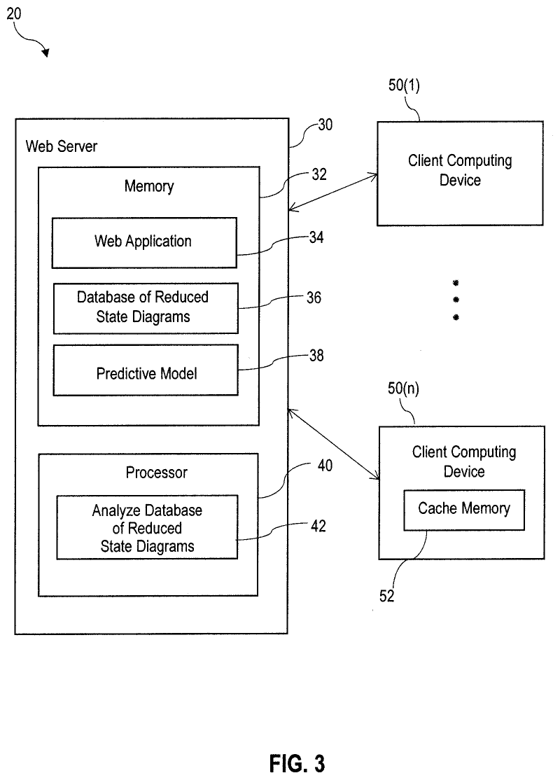

Referring now to FIG. 3, a computing system 20 that includes a web server 30 and client computing devices 50(1)-50(n) that access a web application 34 on the web server 30 will be discussed. Usage of the web application 34 by users operating the client computing devices 50(1)-50(n) is tracked and analyzed to generate a predictive model 38. The predictive model 38 may then be used to predict behavior of a subsequent user accessing the web application 34.

An advantageous use of the predicted model 38 is to push relevant components of the web application 34 to a cache memory 52 on the subsequent user's client computing device 50(n) before being requested by the web application 34. Another advantageous use of the predictive model 38 is to compare the actual behavior of the subsequent user to the predicted behavior to determine efficiency of the subsequent user when accessing the web application 34, or to determine anomalies of the subsequent user when accessing the web application 34.

As will be discussed in more detail below, web application usage during user sessions can leave digital footprints that can be defined by state diagrams. State diagrams include transition sequences between the states, and the transition sequences that are clustered together are advantageously reduced to simplify the vector space. An example transition sequence between states may be several mouse clicks followed by a keyboard input. This results in reduced state diagrams which are then analyzed by a processor 40 to generate the predictive model 38.

The illustrated web server 30 includes a memory 30 with the web application 34 stored therein. The web application 34 may be a Software as a Service (SaaS) application, for example. The processor 40 is coupled to the memory 30 and is configured to perform a series of steps based on the web application 34 being accessed by the users of the client computing devices 50(1)-50(n). The client computing devices 50(1)-50(n) may be generally referred to as client computing devices 50.

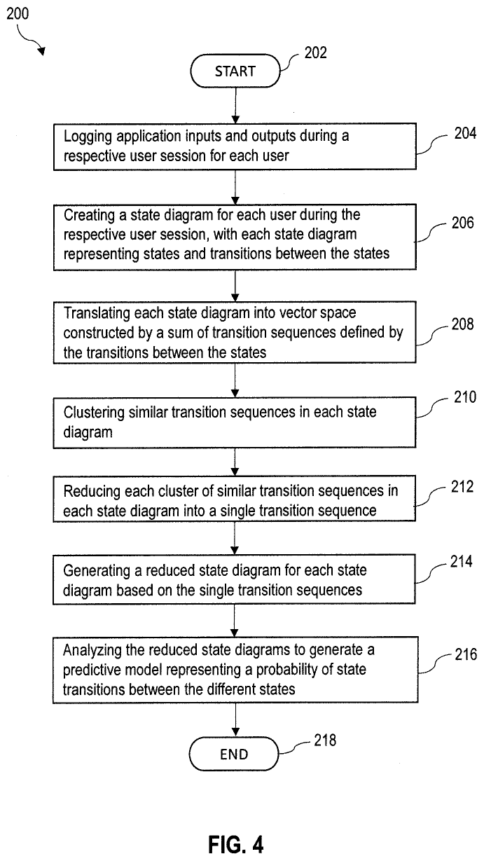

The steps performed by the processor 40 to generate the predictive model 38 will be discussed in reference to the flowchart 200 illustrated in FIG. 4. From the Start (Block 202), application inputs and outputs are logged during a respective user session for each user at Block 204. The processor 40 creates a state diagram for each user at Block 206 during the respective user session, with each state diagram representing states and transitions between the states.

Each state diagram is translated into vector space constructed by a sum of transition sequences defined by the transitions between the states at Block 208. Similar transition sequences are clustered at Block 210 in each state diagram. Each cluster of similar transition sequences in each state diagram is reduced at Block 212 into a single transition sequence. Another example transition sequence between states may be all mouse clicks.

The processor 40 then generates a reduced state diagram for each state diagram based on the single transition sequences at Block 214. The reduced state diagrams are analyzed by the processor 40 at Block 216 to generate the predictive model 38 representing a probability of state transitions between the different states. The method ends at Block 218.

An example web application 34 for discussion purposes is directed to customer relationship management (CRM) which focuses on sales and support. CRM is a major component of the Salesforce platform provided by Salesforce.com, Inc. When the web application 34 is accessed by a user via a client computing device 50, the user goes through a certain sequence of steps. The processor 40 records what the user is doing in the web application 34, and learns what steps the user is taking within the web application 34. This is performed for a large population of users.

An initial state is the user logging into the web server 30, and in response the web server 30 lends a home or log-in page to the client computing device 50. From the home page, the user may then select a particular customer, for example. Selection of the particular customer is another request to the web server 30 via the client computing device 50. The processor 40 thus records that the user transitioned from the home page to the particular customer. Other options by the user from the home page include, for example, create a new account and access emails.

Based on the recordings of how each user uses the web application 34, the processor 40 builds a transition diagram or a history of how each user walks through the web application 34. A transition diagram is also referred to as a state diagram. The processor 40 records everything the user does within the web application 34 and translates this to the state diagram. The user thus moves from state to state with certain transitions therebetween.

Each user in a large population of users has a state diagram corresponding to the steps taken during the user session with the web application 34. A state diagram is an illustration of the states an object can attain as well as the transitions between those states. A state defines a stage in the evolution or behavior of an object, which may be a specific entity in a program or the unit code representing that entity.

To generate the state diagram for each user during a user session, all application inputs and outputs are logged by the processor 40. Inputs are defined by all events in the web application 34 including key events, mouse events, system events and other DOM events. System events include onload events that occur when an object has been loaded. Unload is most often used within the <body> element to execute a script once a web page has completely loaded all content (including images, script files, CSS files, etc.). Outputs are defined by http responses or function calls in the UI.

A user session includes an initial state and an end state. The initial state of the web application 34 is based on an entry level URI request, such as a login screen or a home page. The end state is based on a logoff event or a close window event of the main application.

As an example, two different users log-in to the web application 34, and one user goes to customer A and the other user goes to customer C. The transitions being tracked by the processor 40 are different because the customers are different, but the transitions are also similar since both of the users are going from the log-in page to a customer.

Each state diagram is translated into a high dimensional vector space. The high dimensional vector space is constructed by the sum of its transition sequences. Transition sequences are defined by the transition between states such as:
Transition sequence(State A→State B)=function(key event X, mouse event Y, key event Z, . . . )

Since a state represents a response object it is common that they lead to multiple response objects. For example, a web page may request multiple objects. In the state diagram this is represented by a state having multiple transitions to other states.

As an example, when a user goes from the log-in page to a particular customer, this may lead to multiple requests to the web server 30. There might be an image or javascript loaded, along with customer data being loaded. One action by the user may lead to multiple requests on the web server 40 which represents a change in states.

When a particular customer web page is requested, the web application 34 generates that page which typically includes banners, headers and images. These requests are analyzed by the processor 40 to better determine the state changes.

The state diagram represents a footprint for usage of the web application 34 during a user session. Among the state diagrams for the large population of users, the processor 40 maps the transition sequences to vector space. This allows the processor 40 to see that transition sequences start to cluster in the vector space. The cluster of transition sequences have similar transitions.

Even though one user goes to customer A and the other user goes to customer C, which are different customers, this results in two different transition sequences in vector space. The distance between these transition sequences is small. Once clustered transition sequences are identified, then there is a better understanding of which transitions are similar.

The processor 40 determines the commonality between the clustered transition sequences, and advantageously reduces the transition sequences to a single sequence that represents the users going from a log-in page to a customer page. Each user's request to a different customer is a separate transition sequence, but the transition sequences for the population of users selecting a customer are all clustered together.

Even though the data is different the processor 40 translates this to a vector space, and the composite transition sequence from a particular user will cluster with the transition sequences from the other users. When mapped to a high dimensional vector space, a cloud of dots occur. The cluster of transition sequences may then be reduced to a single transition sequence since each user is going from the log-in page to a customer even though different customers. This is the common transition that simplifies the modeling by the processor 40.

The transitions may even be combined even if the users can use a different number of key strokes or mouse clicks to go from the log-in page to the customer page. As an example, to get to a particular customer one approach involves using a single mouse click and another approach is to use a couple of keystrokes, such as command C to go to a customer.

In the reduction phase of generating the predictive model 38 the goal is to identify the common pattern. The reduction phase reduces the noise among the transition sequences. The fact that it takes a single mouse click or two keystrokes does not really matter. The cluster of transition sequences are simplified or reduced in the reduction phase to identify the common pattern.

As noted above, other options by the user from the home page include, for example, create a new account and access emails. The state diagrams created for these users are also translated into vector space. As with selecting a particular customer, similar transition sequences for the users creating a new account are clustered together, and similar transition sequences for accessing emails are likewise clustered together.

The predictive model 38 generated by the processor 40 may be a Markov model, for example. In probability theory, a Markov model is a stochastic model used to model randomly changing systems. It is assumed that future states depend only on the current state, not on the events that occurred before it. Generally, this assumption enables reasoning and computation with the model that would otherwise be intractable. For this reason, in the fields of predictive modeling and probabilistic forecasting, it is desirable for a given model to exhibit the Markov property.

The Markov model 38 may be applied in temporal pattern recognition because it does a good job of modeling the probability of a sequence of events. The Markov model 38 consists of a finite set of states, each of which is associated with a probability distribution. The probability distribution is generally multi-dimensional. Transitions among the states are governed by a set of probabilities called transition probabilities. In a particular state an outcome or observation can be generated, according to the associated probability distribution of the current state.

Using the predictive model 38, user behavior can be predicted because over time the predictive model 38 has access to a vast store of information from the large population of users. Using this information the predictive model 38 can determine transition probabilities for each behavior state even though the predictive model 38 does not know exactly what the user intends.

As an example, after a user logs into the web application, the user may have a 50% probability of selecting a customer, a 25% probability of creating a new account, a 15% probability of checking emails, and a 10% probability of selecting a different option. Once the predictive model 38 is stable, certain actions may be taken by the web server 30 for the benefit of the user.

When a user goes to a particular customer from the log-in page, the web browser on the client computing device 50 needs to load banners, headers and images. The banners, headers and images are common regardless of the customer being selected. An advantage of the predictive model 38 is that the processor 40 pro-actively pushes, based on the predicted behavior, the banners, headers and images of the web application 34 to the cache memory 52 in the client computing device 50 before being requested by the web application 34. If the user does select a particular customer, then the banners, headers and images are loaded faster since they are in the cache memory 52 in the client computing device 50. This provides a more pleasant user experience.

The predictive model 38 is not limited to proactively pushing javascript files and images to the cache memory 52 for a customer in this example. The predictive model 38 may also proactively pushing applicable javascript files and images for the other high probability actions that may be taken by the user, such as creating a new account or accessing emails.

The predictive model 38 may also be used to compare the actual behavior of the user to the predicted behavior to determine efficiency of the user when accessing the web application 34. If the user is inefficiently using the web application to perform a desired task, feedback may be provided to the user so as to make the user aware that a more efficient approach may be taken for performing the desired task. Similarly, if the predictive model 38 determines that there are anomalies of the user accessing the web application, corrective action may be taken.

Another aspect is directed to a non-transitory computer readable medium for operating a web server 30 comprising a web application 34 to be accessed by a plurality of users, and with the non-transitory computer readable medium having a plurality of computer executable instructions for causing the web server 30 to perform steps that include logging application inputs and outputs during a respective user session for each user, and creating a state diagram for each user during the respective user session. Each state diagram represents states and transitions between the states. Each state diagram is translated into vector space constructed by a sum of transition sequences defined by the transitions between the states. Similar transition sequences in each state diagram are clustered. Each cluster of similar transition sequences in each state diagram are reduced into a single transition sequence. The steps further include generating a reduced state diagram for each state diagram based on the single transition sequences, and analyzing the reduced state diagrams to generate a predictive model representing a probability of state transitions between the different states.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

That which is claimed:

1. A web server comprising:
a memory comprising a web application stored therein; and
a processor coupled to said memory and configured to perform the following based on the web application being accessed by a plurality of users:
log application inputs and outputs during a respective user session for each user,
create a state diagram for each user during the respective user session based on the logged application inputs and outputs, with each state diagram representing states and transitions between the states,
translate each state diagram into vector space constructed by a sum of transition sequences defined by the transitions between the states,
cluster similar transition sequences in each state diagram,
reduce each cluster of similar transition sequences in each state diagram into a single transition sequence,
generate a reduced state diagram for each state diagram based on the single transition sequences, and
analyze the reduced state diagrams to generate a predictive model representing a probability of state transitions between the different states.

2. The web server according to claim 1 wherein said processor is further configured to use the predictive model to predict behavior of a subsequent user when accessing the web application.

3. The web server according to claim 2 wherein the subsequent user accesses the web application via a client computing device comprising a cache memory, and wherein said processor pro-actively pushes, based on the predicted behavior, relevant components of the web application to the cache memory before being requested by the web application.

4. The web server according to claim 2 wherein said processor compares actual behavior of the subsequent user to the predicted behavior to determine efficiency of the subsequent user when accessing the web application.

5. The web server according to claim 2 wherein said processor compares actual behavior of the subsequent user to the predicted behavior to determine anomalies of the subsequent user when accessing the web application.

6. The web server according to claim 1 wherein said processor is configured to cluster the similar transition sequences in each state diagram using cosine distance calculations between equal events.

7. The web server according to claim 1 wherein the predictive model comprises a Markov model.

8. The web server according to claim 1 wherein the application inputs being logged include at least one of keyboard events, mouse events, onload events and document object management (DOM) events; and wherein the application outputs being logged include at least one of hypertext transfer protocol (http) responses and user interface function calls.

9. The web server according to claim 1 wherein said processor is further configured to eliminate transition sequences that are not based on user input and were generated based on system events.

10. The web server according to claim 1 wherein the web application comprises a Software as a Service (SaaS) application.

11. A method for operating a web server comprising a web application to be accessed by a plurality of users, and comprising:
logging application inputs and outputs during a respective user session for each user;
creating a state diagram for each user during the respective user session based on the logged application inputs and outputs, with each state diagram representing states and transitions between the states;
translating each state diagram into vector space constructed by a sum of transition sequences defined by the transitions between the states;
clustering similar transition sequences in each state diagram;
reducing each cluster of similar transition sequences in each state diagram into a single transition sequence;
generating a reduced state diagram for each state diagram based on the single transition sequences; and
analyzing the reduced state diagrams to generate a predictive model representing a probability of state transitions between the different states.

12. The method according to claim 11 further comprising using the predictive model to predict behavior of a subsequent user when accessing the web application.

13. The method according to claim 12 wherein the subsequent user accesses the web application via a client computing device comprising a cache memory, and the method further comprising pro-actively pushing, based on the predicted behavior, relevant components of the web application to the cache memory before being requested by the web application.

14. The method according to claim 12 further comprising comparing actual behavior of the subsequent user to the predicted behavior to determine efficiency of the subsequent user when accessing the web application.

15. The method according to claim 12 further comprising comparing actual behavior of the subsequent user to the predicted behavior to determine anomalies of the subsequent user when accessing the web application.

16. The method according to claim 11 wherein the predictive model comprises a Markov model.

17. A non-transitory computer readable medium for operating a web server comprising a web application to be accessed by a plurality of users, and with the non-transitory computer readable medium having a plurality of computer executable instructions for causing the web server to perform steps comprising:
logging application inputs and outputs during a respective user session for each user;
creating a state diagram for each user during the respective user session based on the logged application inputs and outputs, with each state diagram representing states and transitions between the states;
translating each state diagram into vector space constructed by a sum of transition sequences defined by the transitions between the states;
clustering similar transition sequences in each state diagram;
reducing each cluster of similar transition sequences in each state diagram into a single transition sequence;
generating a reduced state diagram for each state diagram based on the single transition sequences; and
analyzing the reduced state diagrams to generate a predictive model representing a probability of state transitions between the different states.

18. The non-transitory computer readable medium according to claim 17 further comprising using the predictive model to predict behavior of a subsequent user when accessing the web application.

19. The non-transitory computer readable medium according to claim 18 wherein the subsequent user accesses the web application via a client computing device comprising a cache memory, and further comprising the step of pro-actively pushing, based on the predicted behavior, relevant components of the web application to the cache memory before being requested by the web application.

20. The non-transitory computer readable medium according to claim 17 wherein the predictive model comprises a Markov model.
